(19) United States
(12) Patent Application Publication
(10) Pub. No.: US 2015/0084458 A1
(43) Pub. Date: Mar. 26, 2015

(54) ELECTRIC MOTOR

(71) Applicant: Komatsu Ltd., Tokyo (JP)

(72) Inventors: Hiroyuki Tokunaga, Hiratsuka-shi (JP); Ryo Ono, Shimotsuga-gun (JP); Akira Okabe, Naka-gun (JP); Natsuki Watanabe, Hiratsuka-shi (JP)

(73) Assignee: KOMATSU LTD., Tokyo (JP)

(21) Appl. No.: 14/365,256

(22) PCT Filed: Nov. 14, 2012
(86) PCT No.: PCT/JP2012/079549

§ 371 Date: Jun. 13, 2014

(30) Foreign Application Priority Data
Mar. 26, 2012 (JP) 2012-068816

(51) Int. Cl. H02K 5/22

(52) U.S. Cl. CPC H02K 5/225
USPC 310/71

(57) ABSTRACT

An electric motor includes: a ring-shaped stator attached to an inside of a tubular body part; a rotor rotatably arranged inside in a radial direction of the stator; and a tabular member attached to one end of the body part and including a power supply cable through-hole through which a power supply cable pierces, the power supply cable being pulled out from a coil included by the stator, wherein the stator and the tabular member are rotatable around a rotation center axis of the rotor, and a position of the power supply cable pulled out from the coil and a position of the power supply cable through-hole can be changed in a circumferential direction of the body part.

### FIELD

The present invention relates to an electric motor.

### BACKGROUND

An electric motor is used for various purposes. To drive an electric motor, it is necessary to supply electric power from a power source. In Patent Literature 1, it is described to change an extracting direction of a lead wire to supply the electric power to a stator.

### CITATION LIST

### Patent Literature

Patent Literature 1: Japanese Laid-open Patent Publication No. 2006-191719

### SUMMARY

### Technical Problem

In a technique described in Patent Literature 1, to change the extracting direction of a lead wire, it is necessary to prepare enough length thereof. Thus, it is necessary to store the lead wire of the enough length in a chassis of an electric motor, whereby the chassis may become larger.

A purpose of the present invention is to control a size increase of a chassis in changing a position of a power supply cable pulled out from a coil included by a stator of an electric motor.

### Solution to Problem

According to the present invention, an electric motor comprises: a ring-shaped stator attached to an inside of a tubular body part; a rotor rotatably arranged inside in a radial direction of the stator; and a tabular member attached to one end of the body part and including a power supply cable through-hole through which a power supply cable pierces, the power supply cable being pulled out from a coil included by the stator, wherein the stator and the tabular member are rotatable around a rotation center axis of the rotor, and a position of the power supply cable pulled out from the coil and a position of the power supply cable through-hole can be changed in a circumferential direction of the body part.

In the present invention, it is preferable that both of the stator and the tabular member are rotatable at a same rotation angle around the rotation center axis of the rotor.

In the present invention, it is preferable that the electric motor further comprises: a plurality of first attachment parts to attach the tabular member to the body part, the plurality of first attachment parts being provided to the body part and arranged at regular pitches on a first pitch circle having a diameter smaller than an outer diameter of the body part; and a plurality of second attachment parts to attach the stator to the body part, the plurality of second attachment parts being provided to the body part and arranged at regular pitches on a second pitch circle having a diameter smaller than the outer diameter of the body part, wherein one of the number of first attachment parts and the number of second attachment parts is an integral multiple of the other of the number of first attachment parts and the number of second attachment parts.

In the present invention, it is preferable that the number of the first attachment parts and the number of the second attachment parts are a same.

In the present invention, it is preferable that the electric motor further comprises a terminal box which is attached to the tabular member and stores a terminal to which the power supply cable is connected, wherein, in the terminal box, a power cable introduction-hole is arranged outside in the radial direction of the body part, a power cable to supply electric power of a power source to the coil being led to the terminal through the power cable introduction-hole.

In the present invention, it is preferable that the terminal box includes two attachment surfaces which face the tabular member and include a power supply cable hole through which the power supply cable passes.

In the present invention, it is preferable that the power supply cable having pierced through the power supply cable through-hole is bent outside in the radial direction of the tabular member and arranged between the two attachment surfaces in a state that the power supply cable is extended outside in the radial direction of the tabular member, and the power supply cable between the two attachment surfaces is arranged at a center of the two attachment surfaces.

In the present invention, it is preferable that each of the two attachment surfaces includes a lid bolt-hole to which a bolt to attach a lid to the power supply cable hole is attached.

In the present invention, it is preferable that a terminal box bolt-hole pierces through the two attachment surfaces, a bolt to attach the terminal box to the tabular member piercing through the terminal box bolt-hole.

According to the present invention, an electric motor comprises: a ring-shaped stator attached to an inside of a tubular body part; a rotor rotatably arranged inside in a radial direction of the stator; a tabular member attached to one end of the body part and including a power supply cable through-hole through which a power supply cable to supply electric power to a coil attached to the stator pierces; and a terminal box which is attached to the tabular member and stores a terminal to which the power supply cable having pierced through the power supply cable through-hole is connected, wherein the stator and the tabular member are rotatable around a rotation center axis of the rotor, and a position of the power supply cable pulled out from the coil and a position of the power supply cable through-hole can be changed in a circumferential direction of the body part, and wherein in the terminal box, a power cable introduction part is arranged outside in the radial direction of the body part, a power cable to supply electric power of a power source to the coil being introduced to the terminal through the power cable introduction part.

According to the present invention, an electric motor comprises: a ring-shaped stator attached to an inside of a tubular body part; a rotor rotatably arranged inside in a radial direction of the stator; a tabular member attached to one end of the body part and including a power supply cable through-hole through which a power supply cable pierces, the power supply cable being pulled out from a coil included by the stator; and a terminal box which is attached to the tabular member and stores a terminal to which the power supply cable is connected, wherein the terminal box includes: a power cable introduction-hole which is arranged outside in the radial direction of body part and leads a power cable to supply electric power of a power source to the coil to the terminal; and two attachment surfaces which face the tabular member and include a power supply cable hole through which the power supply cable passes.

In the present invention, it is preferable that the power supply cable having pierced through the power supply cable through-hole is bent outside in the radial direction of the tabular member and arranged between the two attachment surfaces in a state that the power supply cable is extended outside in the radial direction of the tabular member, and the power supply cable between the two attachment surfaces is arranged at a center of the two attachment surfaces.

In the present invention, it is preferable that each of the two attachment surfaces includes a lid bolt hole to which a bolt to attach a lid to the power supply cable hole is attached.

In the present invention, it is preferable that a terminal box bolt-hole pierces through the two attachment surfaces, a bolt to attach the terminal box to the tabular member piercing through the terminal box bolt-hole.

In the present invention, it is preferable that the power cable can be introduced into the terminal box from one end side or the other end side of the body part through the power cable introduction-hole.

In the present invention, it is possible to control the size increase of a chassis in changing a position of a power supply cable pulled out from a coil included by a stator of an electric motor.

### BRIEF DESCRIPTION OF DRAWINGS

FIG. 1 is a sectional view illustrating a structure of an electric motor according to the present embodiment.

FIG. 2 is an A-A arrow view of FIG. 1.

FIG. 3 is an elevation view of a rear flange.

FIG. 4 is a view illustrating a relationship between a first attachment part and a second attachment part included by a body part of a chassis of the electric motor according to the present embodiment.

FIG. 5 is a view illustrating a state in which a stator is rotated around a rotation center axis of a rotor.

FIG. 6 is a view illustrating a state in which the rear flange is rotated around the rotation center axis of the rotor.

FIG. 7 is a view illustrating a different arrangement example of the first attachment part and the second attachment part.

FIG. 8 is a view illustrating a different arrangement example of the first attachment part and the second attachment part.

FIG. 9 is a view illustrating a different arrangement example of the first attachment part and the second attachment part.

FIG. 10 is a view illustrating an example in a case where a direction of a terminal box is changed.

FIG. 11 is a view illustrating an example in a case where a direction of the terminal box is changed.

FIG. 12 is a view illustrating an example in a case where a direction of the terminal box is changed.

### DESCRIPTION OF EMBODIMENT

A mode for carrying out the invention (embodiment) will be described in detail with reference to the drawings.

<Mechanism of Electric Motor>

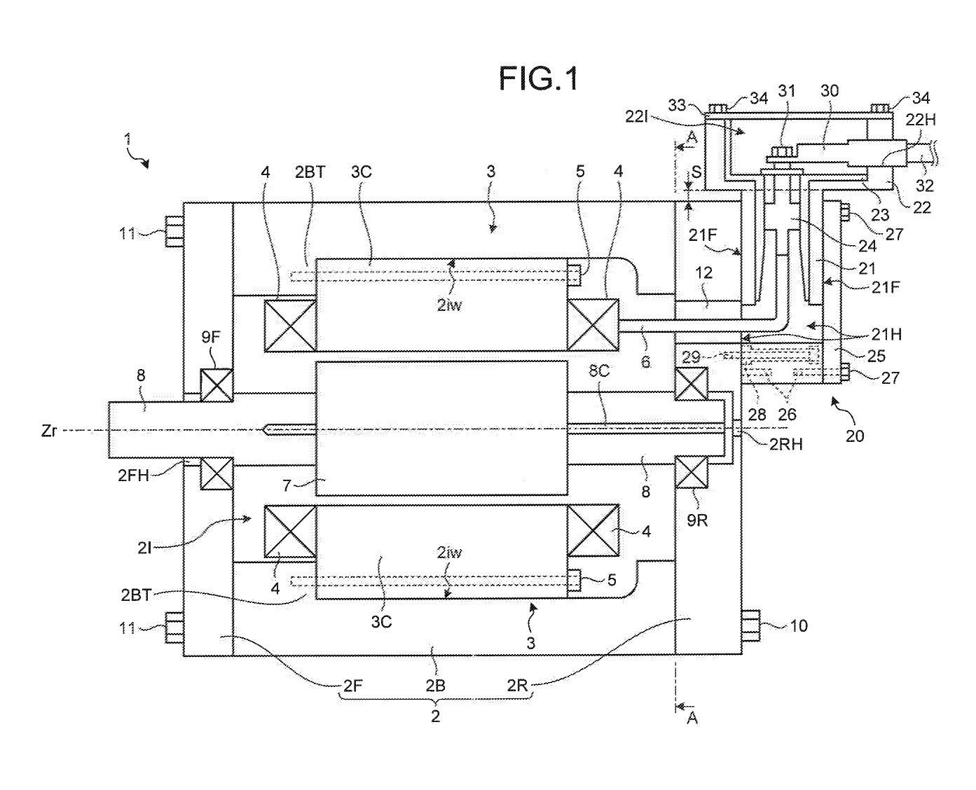

FIG. 1 is a sectional view illustrating a structure of an electric motor according to the present embodiment. An electric motor 1 includes a chassis 2, a stator 3, and a rotor 7. The chassis 2 includes a tubular body part 2B, a rear flange 2R as a tabular member attached to one end of the body part 2B, and a front flange 2F as a tabular member attached to the other end of the body part 2B. A stator core 30 of the stator 3 is attached to an inside of the body part 2B, more specifically, attached to an inner periphery 2iw. The rotor 7 is rotatably arranged inside the stator 3, more specifically, arranged inside in a radial direction of the stator core 3C.

Both of the rear flange 2R and the front flange 2F are disk-shaped members. The rear flange 2R and the front flange 2F are fastened and attached to the body part 2B with bolts 10 and 11 respectively. The chassis 2 stores the stator 3 and the rotor 7 in an inner part 2I, that is, in a space surrounded by the rear flange 2R, the front flange 2F, and the body part 2B. In the present embodiment, the chassis 2 includes the body part 2B, the rear flange 2?, and the front flange 2F, but is not limited to such a form. For example, one of the rear flange 2R and the front flange 2F may be formed integrally with the body part 2B by molding or the like.

The stator 3 includes the stator core 3C and a coil 4. The stator core 3C is a ring-shaped structural body. The stator core 3C is, for example, a plurality of laminated magnetic steel sheets. On the stator core 3C, a plurality of slots (groove) and a plurality of teeth provided between the adjacent slots are arranged in a circumferential direction. An electric wire is wound around the adjacent slots of the stator core 3C, whereby the coil 4 is attached to the stator core 3C. A power supply cable 6 is pulled out from the coil 4. The power supply cable 6 is an electric wire to supply electric power to the coil 4 and to take out, from the electric motor 1, electric power generated by the coil 4 during regeneration of the electric motor 1. In the present embodiment, the electric motor 1 is a three-phase electric motor. Therefore, there are three power supply cables 6 which are the one to supply the electric power to a coil of a U-phase, the one to supply the electric power to a coil of a V-phase, and the one to supply the electric power to a coil of a W-phase.

The rear flange 2R includes a power supply cable through-hole 12 through which the power supply cable 6 pulled out from the coil 4 included by the stator 3 pierces. The power supply cable 6 pierces through the power supply cable through-hole 12 and is pulled out from the inner part 2I of the chassis 2 to an outer part of the chassis 2.

The stator 3, more specifically, the stator core 3C is arranged, for example, into the body part 2B from an opening part on the side of the rear flange 2R. One end of the stator core 3C is abutted against a small diameter part 2BT of the body part 2B, and a stator fixation bolt 5 is inserted into a through-hole which pierces through in a lamination direction of the plurality of magnetic steel sheets included by the stator core 3C. Then, the stator fixation bolt 5 is screwed into a bolt-hole provided on the small diameter part 2BT, whereby the stator 3 including the stator core 3C and the coil 4 is fastened and fixed to the body part 2B.

The rotor 7 arranged inside the stator 3 is attached to a shaft 8 and rotates along with the shaft 8 around a rotation center axis Zr. In this manner, the rotor 7 and the shaft 8 rotate around the common rotation center axis Zr. The rotor 7 is a cylinder-shaped structural body in which disk-shaped steel sheets (magnetic steel sheet) are laminated. An inner periphery of the stator core 3C and an outer periphery of the rotor 7 are oppositely arranged with a predetermined gap therebetween. Thus, a shape of the inner periphery of the stator core 3C corresponds to a shape of the outer periphery of the rotor 7.

In the present embodiment, a plurality of permanent magnets is embedded into an inner part of the rotor 7. As described, in the present embodiment, the electric motor 1 is an interior permanent magnet (IPM), but may be a surface permanent magnet (SPM). Bearings 9R and 9F are attached respectively on one end side and on the other end side of the shaft 8 attached to the rotor 7. The bearings 9R and 9F are, for example, rolling bearings each of which includes an outer ring, a rolling element, an inner ring, and a cage. In the present embodiment, an outer ring of the bearing 9R is attached to the rear flange 2R and an outer ring of the bearing 9F is attached to the front flange 2F. Inner rings of both of the bearings 9R and 9F are attached to the shaft 8. Since the rear flange 2R and the front flange 2F are attached to the body part 2B, the shaft 8 and the rotor 7 are rotatably supported and arranged in the inner part 2I in the chassis 2 of the electric motor 1.

The shaft 8 protrudes from the front flange 2F to the outer part of the chassis 2. A part, of the shaft 8, protruded from the front flange 2F is joined to an object to be driven by the electric motor 1. Also, a gear, a sprocket, or the like is attached to the protruded part. The shaft 8 includes, in an inner part thereof, a cooling medium path 8C through which a cooling medium (such as oil) passes. The cooling medium path 8C is connected to a path or the like, of a cooling medium, provided in the inner part of the rotor 7. A cooling medium is supplied to the cooling medium path 8C from a cooling medium supply opening 2RH included by the rear flange 2R, whereby the rotor 7 is cooled. The cooling medium having used to cool the rotor 7 outflows from the rotor 7 and is discharged outside in a radial direction by centrifugal force of the rotation of the rotor 7. Then, the cooling medium collides against and cools the coil 4 (especially, coil end which is a part protruded from the stator core 3C in a direction of the rotation center axis Zr). In this manner, in the electric motor 1, the inner part 2I of the chassis 2, and the rotor 7 and the like stored in the inner part of the chassis 2 are cooled by the cooling medium. Note that in the electric motor 1, the rotor 7 and the like may not be cooled by the cooling medium.

<Terminal Box>

The electric motor 1 includes a terminal box 20. The terminal box 20 is attached to the rear flange 2R which is the tabular member. The terminal box 20 stores a terminal 24 to which the power supply cable 6 is connected. An attachment part 21 to be attached to the rear flange 2R and a terminal storing part 22 to store the terminal 24 are provided to the terminal box 20. In the present embodiment, the attachment part 21 and the terminal storing part 22 are formed integrally, but the terminal box 20 is not limited to such a form. For example, the attachment part 21 and the terminal storing part 22 may be prepared as separate members and may be fastened by a bolt.

The attachment part 21 includes two attachment surfaces 21F which contact the rear flange 2R. The two attachment surfaces 21F and 21F are opposing each other and are in parallel. Each of the attachment surfaces 21F and 21F includes a power supply cable hole 21H through which the power supply cable 6 passes, the power supply cable 6 being pulled out from the coil 4 of the stator 3 and piercing through the power supply cable through-hole 12 of the rear flange 2R. Also, the attachment surface 21F faces the rear flange 2R when the terminal box 20 is attached to the rear flange 2R.

The attachment part 21 includes a terminal box bolt-hole 28 which pierces through the two attachment surfaces 21F and 21F. A bolt 29 is made to pierce through the terminal box bolt-hole 28 and is screwed into the rear flange 2R, whereby the attachment part 21 is fastened and fixed to the rear flange 2R. As a result, the terminal box 20 is attached to the rear flange 2R. Here, one of the attachment surfaces 21F faces the rear flange 2R. Note that an O-ring or a gasket is included as a sealing member between the attachment surface 21F and the rear flange 2R. In this manner, the possibility of a leak of the cooling medium, which is in the inner part 2I in the chassis 2 of the electric motor 1, from a gap between the attachment surface 21F and the rear flange 2R can be reduced.

In the present embodiment, the terminal box bolt-hole 28 includes a counterbore part on the side of each of the attachment surfaces 21F and 21F. The depth of the counterbore part is preferably larger than the height of a bolt head of the bolt 29. In this manner, the head of the bolt 29 entered into the counterbore part does not protrude from the attachment surfaces 21F and 21F. Therefore, even when a lid 25 is attached to the attachment surface 21F, a gap is not generated therebetween, and thus, the gap therebetween can be securely sealed. Also, since the counterbore parts are provided on both side of the attachment surfaces 21F and 21F, the head of the bolt 29 can be embedded into the counterbore part even when the terminal box 20 is attached to the rear flange 2R with the attachment surfaces 21F being switched. The depths of the both counterbore parts are preferably the same. In this manner, even when the terminal box 20 is reversed and attached to the rear flange 2R, the same bolt 29 can be used. Therefore, commonization of parts and reduction of the number of parts can be achieved.

When the attachment part 21 is attached to the rear flange 2R, the power supply cable hole 21H of the attachment part 21 and the power supply cable through-hole 12 of the rear flange 2R overlap. Thus, after piercing through the power supply cable through-hole 12, the power supply cable 6 from the coil 4 is led to the power supply cable hole 21H. The power supply cable 6 having pierced through the power supply cable through-hole 12 is bent outside in a radial direction of the rear flange 2R by about 90° and is extended outside in the radial direction of the rear flange 2R. The extending direction of the power supply cable 6 is a direction orthogonal to the rotation center axis Zr. After being bent, the power supply cable 6 is arranged between the two attachment surfaces 21F and 21F, and is led and electrically connected to the terminal 24.

When one attachment surface 21F is attached to the rear flange 2R, the power supply cable hole 21H is in an opened state on the other attachment surface 21F. Since the power supply cable holes 21H and 21H of the attachment surfaces 21F and 21F communicate with each other in an inner part of the attachment part 21, such a state causes the inner part 2I in the chassis 2 of the electric motor 1 to communicate with the outer part. Therefore, to occlude the power supply cable hole 21H of the other attachment surface 21F, the lid 25 is attached thereto. Bolts 27 are screwed into a plurality of lid bolt-holes 26 included by the attachment part 21, whereby the lid 25 is fastened and fixed to the attachment surface 21F. An O-ring or a gasket is included as a sealing member between the attachment surface 21F and the lid 25. In this manner, the possibility of a leak of the cooling medium, which is in the inner part 2I in the chassis 2 of the electric motor 1, from a gap between the attachment surface 21F and the lid 25 can be reduced.

It is preferable that the lid bolt-hole 26 opened to one attachment surface 21F and the lid bolt-hole 26 opened to the other attachment surface 21F include a common center axis. In this manner, the common lid 25 can be used for the both attachment surfaces 26. Also, the depths of the lid bolt-holes 26 respectively opened to the attachment surfaces 21F are preferably the same. In this manner, even when the terminal box 20 is reversed and attached to the rear flange 2R, the same bolt 27 can be used. Therefore, commonization of parts and reduction of the number of parts can be achieved.

An insulator 23 is arranged between the terminal box 20 and the terminal 24. The insulator 23 and the terminal 24 are the combination of different members. Since the insulator 23 and the terminal 24 are not adhered, the two can be separated. The insulator 23 may include, for example, polyester, resin having high insulation such as an epoxy resin and a phenol resin, glass fiber, fiberglass reinforced plastic, or the like. Since the terminal box 20 includes a metal material and has high conductivity, the insulator 23 is included between the terminal 24 and the terminal box 20 to secure the electrical insulation therebetween.

A power cable 32 to supply the electric power of the power source to the coil 4 included by the stator 3 is connected to the terminal 24. A power cable terminal 30 is electrically connected to the power cable 32. The power cable terminal 30 is inserted into a space 22I in an inner part of the terminal storing part 22 from a power cable introduction-hole 22H included by the terminal storing part 22. The power cable introduction-hole 22H is to lead the power cable 32 to the terminal. The power cable introduction-hole 22H is arranged outside in a radial direction of the body part 2B.

The power cable 32 is fastened and fixed to the terminal 24 by a bolt 31 via the power cable terminal 30. In this manner, the terminal 24 and the power cable terminal 30 are electrically connected with each other, and the connected part thereof is arranged in the space 22I in the inner part of the terminal storing part 22. An opening part of the terminal storing part 22 is closed by a lid 33. The lid 33 is fastened and fixed to the terminal storing part 22 by a bolt 34. Note that in the present embodiment, the power cable 32 is fastened and connected to the terminal 24 by the bolt 31, but a connection structure of the power cable 32 and the terminal 24 is not limited to such a structure. For example, the power cable 32 and the terminal 24 may be connected with each other by a connector.

As described above, the power cable introduction-hole 22H is arranged outside in the radial direction of the body part 2B. Also, the terminal box 20 includes the two attachment surfaces 21F and 21F on the attachment part 21. One attachment surface 21F is arranged on a rear side of the other attachment surface 21F. Thus, by changing the attachment surface 21F on the side of the rear flange 2R from one to the other, a direction of the opening of the power cable introduction-hole 22H can be changed by 180°. For example, when the attachment part 21 is attached to the rear flange 2R with the attachment surface 21F on the side of the opening of the power cable introduction-hole 22H facing the rear flange 2R, the side of the opening of the power cable introduction-hole 22H faces the side of the front flange 2F. Also, when the attachment part 21 is attached to the rear flange 2R with the attachment surface 21F on the opposite side of the opening of the power cable introduction-hole 22H facing the rear flange 2R, the side of the opening of the power cable introduction-hole 22H faces the opposite side of the front flange 2F. In this manner, in the electric motor 1, the direction to pull out the power cable 32 from the terminal box 20 can be changed by 180°.

As illustrated in FIG. 1, a predetermined gap S is provided between the terminal storing part 22 of the terminal box 20 and an outer periphery of the chassis 2 to prevent the terminal box 20 from coming into contact with the chassis 2 when the direction of the terminal box 20 is changed. In this manner, even when the direction of the terminal box 20 is changed and the directions of the opening of the power cable introduction-hole 22H is switched, the contact between the terminal box 20 and the chassis 2 can be prevented.

<In Respect to Rotation of Stator and Rear Flange>

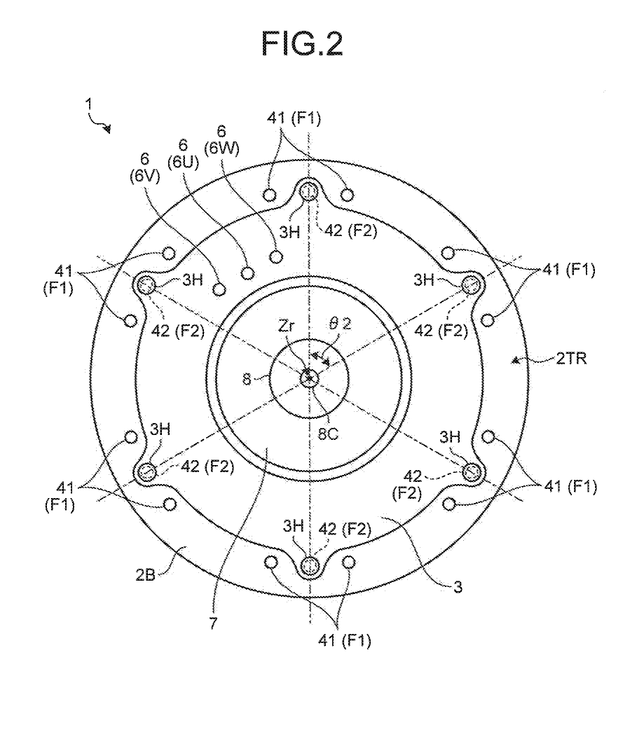

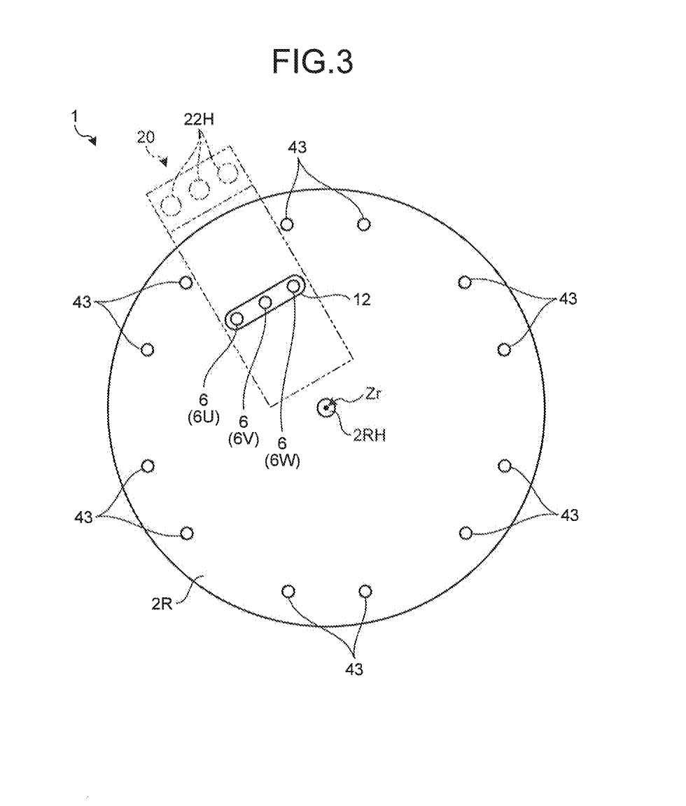

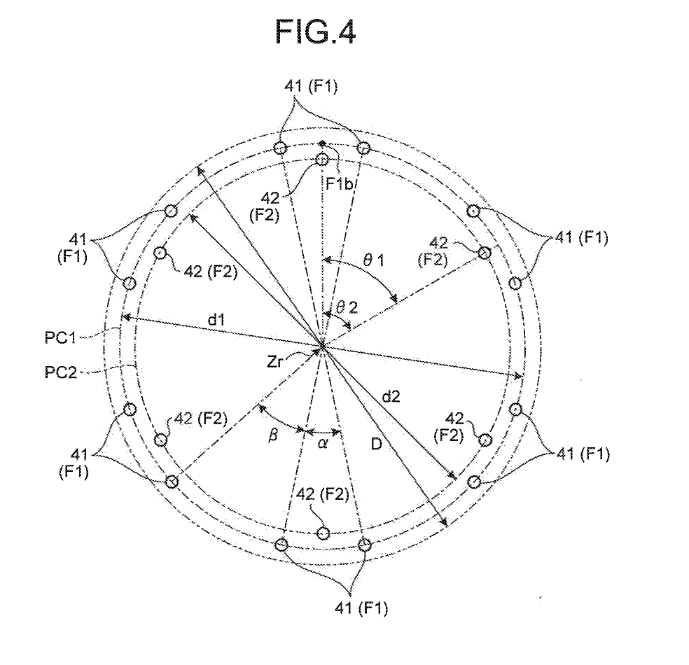

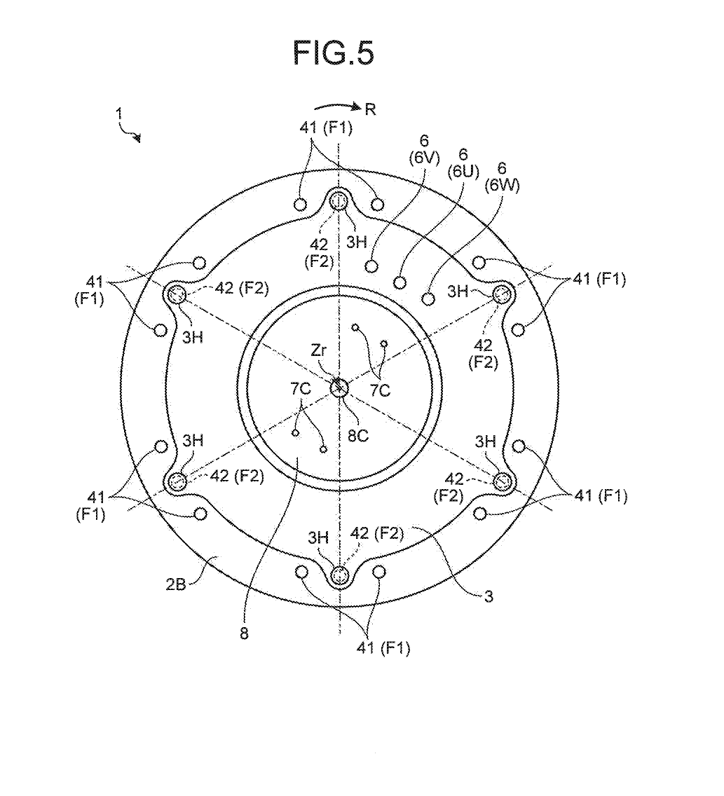

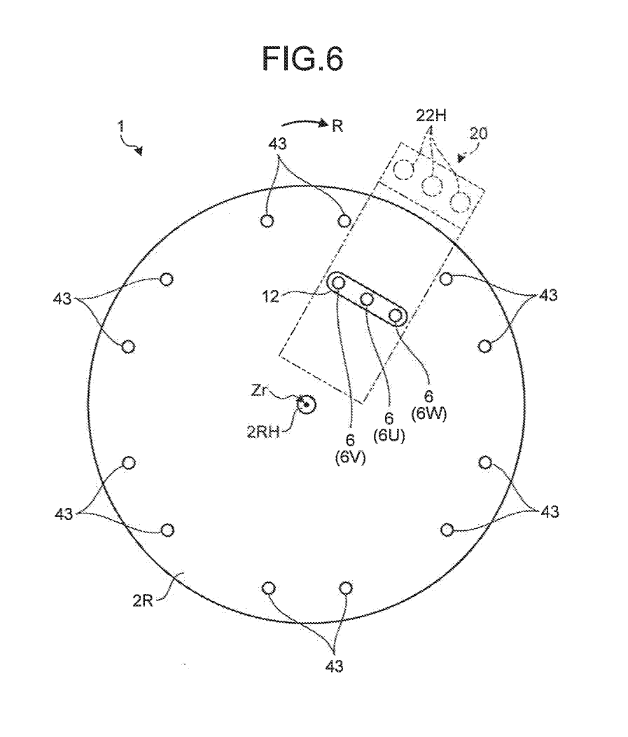

FIG. 2 is an A-A arrow view of FIG. 1. FIG. 3 is an elevation view of the rear flange. FIG. 4 is a view illustrating a relationship between a first attachment part and a second attachment part included by the body part of the chassis of the electric motor according to the present embodiment. FIG. 5 is a view illustrating a state in which the stator is rotated around the rotation center axis of the rotor. FIG. 6 is a view illustrating a state in which the rear flange is rotated around the rotation center axis of the rotor. FIG. 2 and FIG. 5 are views illustrating a state in which the stator fixation bolt 5 illustrated in FIG. 1 is detached from the stator 3. Therefore, in FIG. 2 and FIG. 5, a stator bolt-hole 42 into which the stator fixation bolt 5 is screwed can be seen from a through-hole 3H of the stator 3.

Bolts 10 (see FIG. 1) which pierce through through-holes 43 (see FIG. 3) provided to the rear flange 2R are screwed into a plurality of rear flange bolt-holes 41 provided to one end 2TR of the body part 2B of the chassis 2, whereby the rear flange 2R is attached to the one end 2TR of the body part 2B. The stator fixation bolts 5 are screwed into a plurality of stator bolt-holes 42 provided to the body part 2B, whereby the stator 3 is attached to the inside of the body part 2B.

As illustrated in FIG. 2, in the present embodiment, the rear flange bolt-holes 41 are provided to twelve places and the stator bolt-holes 42 are provided to six places. In a circumferential direction of the body part 2B, two rear flange bolt-holes 41 are provided adjacently to both sides of one stator bolt-hole 42. In this example, the two rear flange bolt-holes 41 provided adjacently to the one stator bolt-hole 42 are referred to as a first attachment part F1, and the stator bolt-hole 42 is referred to as a second attachment part (F2).

In the present embodiment, the stator 3 and the rear flange 2R of the electric motor 1 are rotatable around the rotation center axis Zr of the rotor 7 (or shaft 8), and a position of the power supply cable 6 pulled out from the coil 4 and a position of the power supply cable through-hole 12 can be changed in the circumferential direction of the body part 2B. With such a structure, it is possible to rotate the rear flange 2R around the rotation center axis Zr and to set the terminal box 20, which is attached to the rear flange 2R, in a different position in the circumferential direction of the body part 2B. As a result, when the electric motor 1 is mounted to a vehicle, a device, or the like, flexibility of the routing of the power cable 32 illustrated in FIG. 1 is improved.

To make the stator 3 and the rear flange 2R rotatable around the rotation center axis Zr, as illustrated in FIG. 4, the plurality of first attachment parts F1 and the plurality of second attachment parts F2 are arranged at regular pitches on a predetermined pitch circle PC and provided to the body part 2B. More specifically, the plurality of first attachment parts F1 is arranged at regular pitches on a first pitch circle PC1 having a diameter smaller than an outer diameter D of the body part 2B. Also, the plurality of second attachment part F2 are arranged at regular pitches on a second pitch circle PC2 having a diameter smaller than the outer diameter D of the body part 2B. In an example illustrated in FIG. 4, the diameter d1 of the first pitch circle PC1 is larger than the diameter d2 of the second pitch circle PC2. Since the first attachment part F1 is the adjacent rear flange bolt-holes 41 and 41, the center of the rear flange bolt-hole 41 is arranged on the first pitch circle PC1. Since the second attachment part F2 is the stator bolt-hole 42, the center thereof is arranged on the second pitch circle PC2.

In the present embodiment, among the twelve rear flange bolt-holes 41, as combinations of two adjacent rear flange bolt-holes 41 and 41, there are a combination having a center angle α and a combination having a center angle β, as illustrated in FIG. 4. In the present embodiment, a combination having a smaller center angle is the first attachment part F1. In the present embodiment, α<β, whereby the combination, of two adjacent rear flange bolt-holes 41 and 41, having the center angle α is the first attachment part F1.

The adjacent rear flange bolt-holes 41 and 41 of the first attachment part F1 are preferably provided at regular distances in circumferentially opposite directions from the stator bolt-hole 42 which is the second attachment part F2. That is, a center angle formed by the stator bolt-hole 42, the rotation center axis Zr, and the rear flange bolt-hole 41 on one side in the circumferential direction of the stator bolt-hole 42 is preferably the same as a center angle formed by the stator bolt-hole 42, the rotation center axis Zr, and the rear flange bolt-hole 41 on the other side in the circumferential direction of the stator bolt-hole 42. Also, even when the center angle of the rear flange bolt-hole 41 on the one side is different from the center angle of the rear flange bolt-hole 41 on the other side, it is not a problem if the center angles thereof are different from each other in the same manner in all of the first attachment parts F1.

To arrange the plurality of first attachment parts F1 at regular pitches means that all of the center angles of the adjacent first attachment parts F1 toward the rotation center axis Zr, that is, all angles (center angle) θ1 formed by the adjacent first attachment parts F1 and F1, and the rotation center axis Zr, are the same in the circumferential direction of the body part 2B. In the present embodiment, since the two adjacent rear flange bolt-holes 41 and the 41 correspond to the first attachment part F1, the center angle θ1 of the adjacent first attachment parts F1 is determined based on an intermediate position F1b of the two rear flange bolt-holes 41 and 41.

To arrange the plurality of second attachment parts F2 at regular pitches means that all of the center angles of the adjacent second attachment parts F2 toward the rotation center axis Zr, that is, all angles (center angle) θ2 formed by the adjacent second attachment parts F2 and F2, and the rotation center axis Zr are the same in the circumferential direction of the body part 2B. In the present embodiment, since the six stator bolt-holes 42 arranged in the circumferential direction of the body part 2B correspond to the second attachment parts F2, the center angle θ2 of the adjacent second attachment parts F2 is determined based on a position of each of the stator bolt-holes 42.

In the present embodiment, the electric motor 1 includes six first attachment parts F1 and six second attachment part F2. Since the six first attachment parts F1 and the six second attachment part F2 are arranged at regular pitches, both of the center angles θ1 and θ2 are 60°. In this manner, the stator 3 and the rear flange 2R become rotatable around the rotation center axis Zr. In addition, since θ1=θ2, both of the stator 3 and the rear flange 2R become rotatable at the same rotation angle (in this example, θ1=θ2=60°) around the rotation center axis Zr. In this manner, with positional relationship between the power supply cables 6 (6U, 6W, and 6W) and the power supply cable through-hole 12 included by the rear flange 2R being kept, the position of the stator 3 and the position of the rear flange 2R can be changed in the circumferential direction of the body part 2B. In the present embodiment, since the six first attachment parts F1 and the six second attachment parts F2 are arranged at regular pitches, rotation of both of the stator 3 and the rear flange 2R is at every 60°.

FIG. 5 is a view illustrating a state in which the stator 3 is rotated by 60° around the rotation center axis Zr from the state illustrated in FIG. 2, and FIG. 6 is a view illustrating a state in which the rear flange 2R is rotated by 60° around the rotation center axis Zr from the state illustrated in FIG. 3. In this manner, in the electric motor 1, by rotating the rear flange 2R and the stator 3 at the same rotation angle in the circumferential direction of the body part 2B, the positional relationship between the power supply cable through-hole 12 of the rear flange 2R and the power supply cables 6 (6U, 6W, and 6W) is kept the same before and after the rotation. Therefore, it is not necessary to give extra length to the power supply cable 6 with consideration for the movement of the power supply cable through-hole 12 of the rear flange 2R. Thus, a space to store the extra power supply cable 6 in the chassis 2 is not necessary. As a result, the size increase of the chassis 2 of the electric motor 1 can be controlled. Thus, it is possible to control the size increase of the chassis 2 of the electric motor 1 and to change the position of the terminal box 20 in the circumferential direction of the body part 2B, simultaneously.

Also, when output of the electric motor 1 is large, a great amount of electric power is supplied to the coil 4, whereby the power supply cable 6 becomes thick. As a result, it becomes very difficult to bend the power supply cable 6 and to store the extra power supply cable 6 in the chassis 2. In the electric motor 1, the rear flange 2R and the stator 3 are rotated in the circumferential direction of the body part 2B for a position adjustment of the terminal box 20. Thus, the power supply cable 6 only needs to include the minimum required length. As a result, even when the power supply cable 6 is thick, the position of the terminal box 20 in the circumferential direction of the body part 2B can be easily changed. As just described, the electric motor 1 is effective especially in a case where the power supply cable 6 is thick.

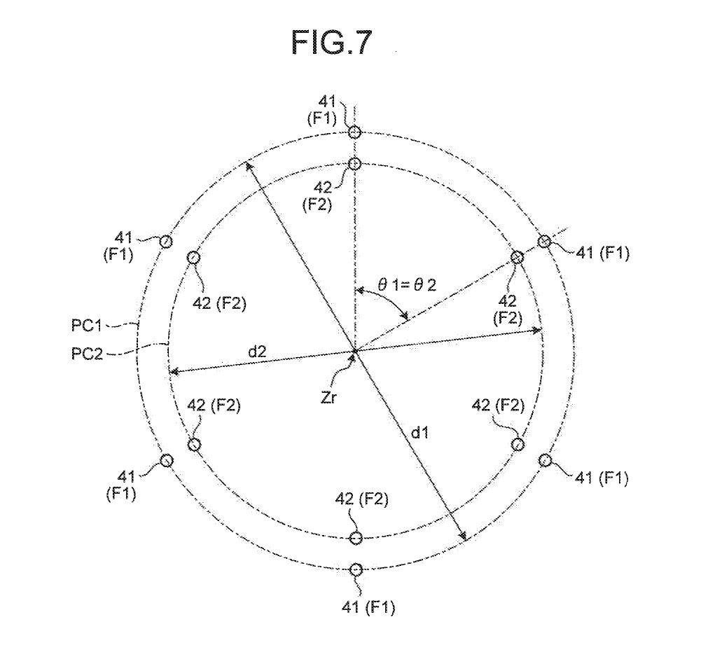

FIG. 7 to FIG. 9 are views illustrating different arrangement examples of a first attachment part and a second attachment part. The arrangement illustrated in FIG. 7 is different from the example illustrated in FIG. 4 in a point that one rear flange bolt-hole 41 is a first attachment part F1, but the other points thereof are similar to the example described above. In this example, six rear flange bolt-holes 41, each of which is the first attachment part F1, are arranged at regular distances on a first pitch circle PC1. The first attachment part F1 is arranged outside in a radial direction of a stator bolt-hole 42 which is a second attachment part F2. Even with such an arrangement, an action and an effect similar to those of the arrangement illustrated in FIG. 4 can be obtained.

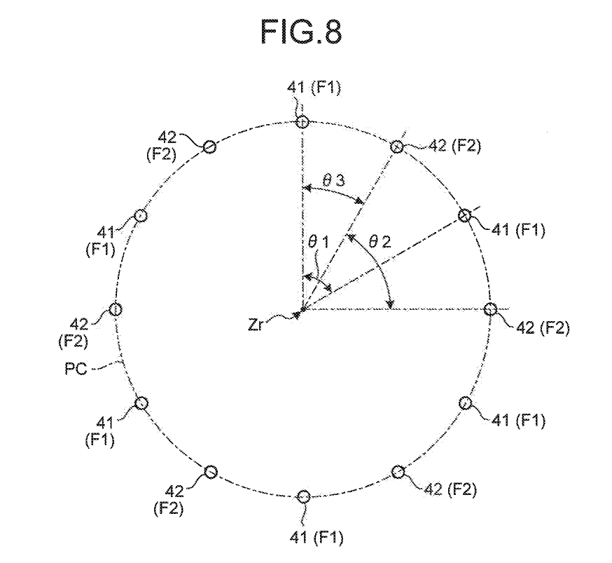

In an example illustrated in FIG. 8, a plurality of first attachment parts F1 and a plurality of second attachment parts F2 are respectively arranged at regular distances on a same pitch circle PC. That is, the pitch circle PC corresponds to the first pitch circle and the second pitch circle. In this case, the first attachment parts F1 and the second attachment parts F2 are arranged alternately in a circumferential direction of the pitch circle PC. A center angle θ1 of the adjacent first attachment parts F1 and F1 and a center angle θ2 of the adjacent second attachment parts F2 and F2 are the same.

Also, in this example, a center angle θ3 of the adjacent first attachment part F1 and second attachment part F2 is θ1/2=θ2/2. Thus, all of the plurality of first attachment parts F1 and all of the plurality of second attachment parts F2 are arranged at regular pitches on the pitch circle PC. Even with such an arrangement, an action and an effect similar to those of the arrangement illustrated in FIG. 4 can be obtained. Note that in this example, when θ1 and θ2 are the same, θ3 is not necessarily θ1/2 (=θ2/2).

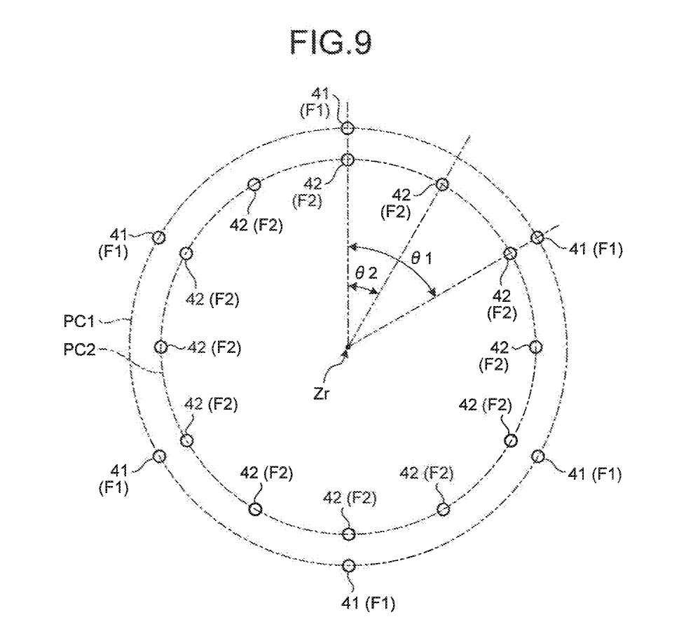

In an example illustrated in FIG. 9, the number of second attachment parts F2 is made greater than the number of first attachment parts F1, in respect to the example illustrated in FIG. 7. In this example, there are six first attachment parts F1, but there are twelve second attachment parts F2, the number of the second attachment parts F2 being twice the number of the first attachment parts F1. The first attachment parts F1 and the second attachment parts F2 are arranged respectively at regular pitches on a first pitch circle PC1 and a second pitch circle PC2. Therefore, a center angle of the adjacent first attachment parts F1 and F1 is θ1/2=θ2=30°. In this example, since there are twelve second attachment parts F2 to attach the stator 3 to the body part 2B, the stator 3 is rotatable in the circumferential direction of the body part 2B at every 30°. Therefore, the stator 3 becomes rotatable at the same rotation angle with the rear flange 2R which is rotatable at every 60° in the circumferential direction of the body part 2B. Also, when there are twelve first attachment parts F1 and six second attachment parts F2, both of the stator 3 and the rear flange 2R are rotatable at the same rotation angle around the rotation center axis Zr.

In addition, when there are six first attachment parts F1 and eighteen second attachment parts F2, the rear flange 2R is rotatable at every 60° and the stator 3 is rotatable at every 20°. Also in this case, both of the stator 3 and the rear flange 2R are rotatable at the same rotation angle around the rotation center axis Zr. Altogether, in the present embodiment, the first attachment parts F1 are arranged at regular pitches on the first pitch circle, and the second attachment parts F2 are arranged at regular pitches on the second pitch circle, and one of the number of first attachment parts F1 and the number of second attachment parts F2 only needs to be an integral multiple of the other. When such a relationship is satisfied, both of the stator 3 and the rear flange 2R are rotatable at the same rotation angle in the circumferential direction of the body part 2B around the rotation center axis Zr.

As illustrated in FIG. 9, the number of first attachment parts F1 and the number of second attachment parts F2 may be different from each other, but when the stator 3 and the rear flange 2R are rotated only at the same rotation angle, the numbers thereof are preferably the same. In this manner, less working processes of the first attachment parts F1 and the second attachment parts F2 are necessary. Also, in respect to one of the stator 3 and the rear flange 2R, when positions are provided more finely in the circumferential direction of the body part 2B, the number of first attachment parts F1 and the number of second attachment parts F2 are preferably different from each other, with the relationship described above being satisfied.

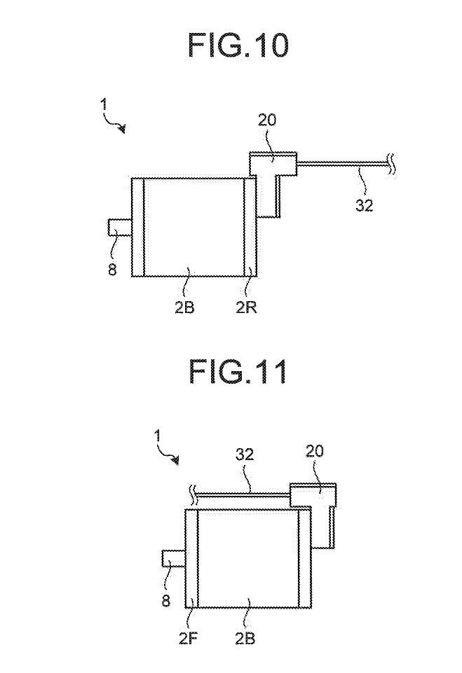

FIG. 10 to FIG. 12 are views illustrating examples in a case where a direction of the terminal box is changed. FIG. 10 and FIG. 11 are examples of changing a direction of the power cable introduction-hole 22H of the terminal box 20 illustrated in FIG. 1. In the example illustrated in FIG. 10, the power cable introduction-hole 22H faces a direction which makes it possible to introduce the power cable 32 into the terminal box 20 from one end (on the side of rear flange 2R) of the body part 2B. That is, it is an example of introducing the power cable 32 into the terminal box 20 from the side of the rear flange 2R by making the power cable introduction-hole 22H of the terminal box 20 face the opposite side of a protruding direction of the shaft 8. FIG. 11 is an example in which the power cable introduction-hole 22H faces a direction which makes it possible to introduce the power cable 32 into the terminal box 20 from the other end side (on the side of front flange 2F) of the body part 2B. That is, it is an example of introducing the power cable 32 into the terminal box 20 from the side of the front flange 2F by making the power cable introduction-hole 22H of the terminal box 20 face the protruding direction of the shaft 8. As just described, it is possible to introduce the power cable 32 into the terminal box 20 from one end side or the other end side of the body part 2B through the power cable introduction-hole 22H. With such a structure, in respect to the terminal box 20, it is possible to change the direction of the power cable introduction-hole 22H and to change the introduction direction of the power cable 32 by switching the two attachment surfaces 21F and 21F. Thus, it is not necessary to prepare a new part.

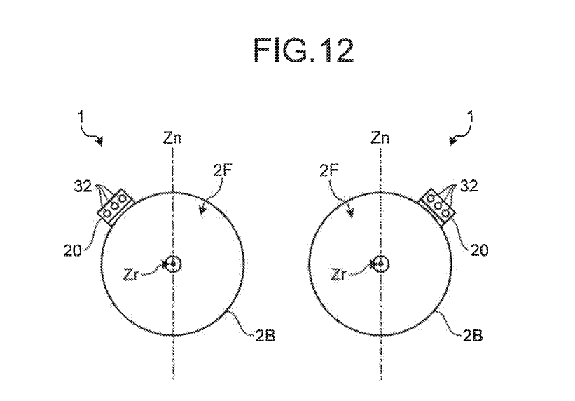

In an example illustrated in FIG. 12, when two electric motors 1 are lined up and arranged, for example, in a working vehicle such as a construction machine including a wheel loader or the like, the terminal boxes 20 are inclined in different directions around the rotation center axis Zr. In this example, in the two electric motors 1 lined up and arranged, the terminal boxes 20 are inclined outside around predetermined axis Zn. In the electric motor 1, both of the stator 3 and the rear flange 2R can be rotated around the rotation center axis Zr. Thus, the position of the terminal box 20 in the circumferential direction of the body part 2B can be changed without the preparation of a new part.

Note that in the present embodiment, when the electric motor 1 is cooled with a cooling medium, the cooling medium may move to the side of the terminal box 20 through the power supply cable through-hole 12 and the power supply cable hole 21H. The space 22I in the inner part of the terminal storing part 22 included by the terminal box 20 is sealed tightly, from the outer part, by a sealing member between the lid 33 and the terminal storing part 22, a sealing member between the insulator 23 and the terminal 24, a sealing member between the insulator 23 and the terminal storing part 22, and a sealing member between the power cable introduction-hole 22H and the power cable 32, but it is preferable to prevent the movement of the cooling medium to the side of the terminal box 20, as much as possible. From this perspective, the terminal box 20 is preferably arranged on the upper side of the electric motor 1.

As described above, in the electric motor 1, it becomes possible, by the change of attachment direction of the terminal box 20 and the rotation of the stator 3 and the rear flange 2R, to change the introduction direction of the power cable 32 into the terminal box 20 and to change the inclination of the terminal box 20. Thus, in the electric motor 1, it is not necessary to prepare exclusive parts for the terminal box 20, the stator 3, and the rear flange 2R to change the introduction direction of the power cable 32 or to change the inclination of the terminal box 20 around the rotation center axis Zr. As a result, the electric motor 1 only needs a set of the same terminal box 20, the stator 3, and the like, whereby parts management can be simplified. Also, since it is not necessary to manufacture various kinds and small quantities of parts, manufacturing cost of the electric motor 1 can be controlled.

In addition, in the electric motor 1, since the direction and the inclination around the rotation center axis Zr of the terminal box 20 can be easily adjusted, flexibility of the arrangement of the power cable 32 is improved. As a result, when the electric motor 1 is mounted to an existing vehicle or an existing device and even in a case where the arrangement of the power cable 32 cannot be changed greatly, it becomes easier to fit to the existing arrangement without the preparation of a special part. Moreover, also in a case where a vehicle or a device is newly designed, since the electric motor 1 has high flexibility of the arrangement of the power cable 32, flexibility in designing the arrangement of the electric motor 1, and a control device, the power cable 32, or other devices of the electric motor 1 can be improved. Also in this case, it is not necessary to consider a cost increase caused by the arrangement change of the terminal box 20 of the electric motor 1. In addition, in a case where it becomes necessary to change the introduction direction of the power cable 32 into the terminal box 20 during a conversion or the like of a vehicle or a device to which the electric motor 1 is mounted, it is easy to correspond to the change without any cost increase.

In the descriptions above, the number of attachment surfaces 21F of the terminal box 20 is described as two, but the number of attachment surfaces 21F only needs to be at least two. For example, when there are four attachment surfaces 21F, the introduction direction of the power cable 32 into the terminal box 20 can be changed into four directions. For example, in this case, to join the opposing two attachment surfaces 21F and 21F, two opposing attachment surfaces are newly provided.

In the above, the present embodiment has been described, but the present embodiment is not limited to the contents described above. Also, the constituent elements of the present embodiment described above include what can be easily assumed by one skilled in the art and what is practically the same, that is, what is within the equivalent scope. Moreover, the described constituent elements can be combined appropriately. Also, omission, substitution, and a change of the constituent elements can be made in various ways within the scope of the present embodiment. An applicable object of the electric motor of the present embodiment is not specifically limited. The electric motor of the present embodiment can be applied to a construction machine, working vehicle, and the like.

### REFERENCE SIGNS LIST

1 ELECTRIC MOTOR
2 CHASSIS
2B BODY PART
2F FRONT FLANGE
2I INNER PART
2R REAR FLANGE
3 STATOR
3C STATOR CORE
4 COIL
5 STATOR FIXATION BOLT
6 POWER SUPPLY CABLE
7 ROTOR
8 SHAFT
9F, 9R BEARING
12 POWER SUPPLY CABLE THROUGH-HOLE
20 TERMINAL BOX
21 ATTACHMENT PART
21F ATTACHMENT SURFACE
22 TERMINAL STORING PART
22B BOTTOM PART
22I SPACE
22H POWER CABLE INTRODUCTION-HOLE
22W WALL
23 INSULATOR
24 TERMINAL

1. An electric motor comprising:
a ring-shaped stator attached to an inside of a tubular body part;
a rotor rotatably arranged inside in a radial direction of the stator; and
a tabular member attached to one end of the body part and including a power supply cable through-hole through which a power supply cable pierces, the power supply cable being pulled out from a coil included by the stator,
wherein the stator and the tabular member are rotatable around a rotation center axis of the rotor, and a position of the power supply cable pulled out from the coil and a position of the power supply cable through-hole can be changed in a circumferential direction of the body part.

2. The electric motor according to claim 1, wherein both of the stator and the tabular member are rotatable at a same rotation angle around the rotation center axis of the rotor.

3. The electric motor according to claim 1, further comprising:
a plurality of first attachment parts to attach the tabular member to the body part, the plurality of first attachment parts being provided to the body part and arranged at regular pitches on a first pitch circle having a diameter smaller than an outer diameter of the body part; and
a plurality of second attachment parts to attach the stator to the body part, the plurality of second attachment parts being provided to the body part and arranged at regular pitches on a second pitch circle having a diameter smaller than the outer diameter of the body part,
wherein one of the number of first attachment parts and the number of second attachment parts is an integral multiple of the other of the number of first attachment parts and the number of second attachment parts.

4. The electric motor according to claim 3, wherein the number of the first attachment parts and the number of the second attachment parts are a same.

5. The electric motor according to claim 1, further comprising a terminal box which is attached to the tabular member and stores a terminal to which the power supply cable is connected,
wherein, in the terminal box, a power cable introduction-hole is arranged outside in the radial direction of the body part, a power cable to supply electric power of a power source to the coil being led to the terminal through the power cable introduction-hole.

6. The electric motor according to claim 5, wherein the terminal box includes two attachment surfaces which face the tabular member and include a power supply cable hole through which the power supply cable passes.

7. The electric motor according to claim 6, wherein the power supply cable having pierced through the power supply cable through-hole is bent outside in the radial direction of the tabular member and arranged between the two attachment surfaces in a state that the power supply cable is extended outside in the radial direction of the tabular member, and
the power supply cable between the two attachment surfaces is arranged at a center of the two attachment surfaces.

8. The electric motor according to claim 6, wherein each of the two attachment surfaces includes a lid bolt-hole to which a bolt to attach a lid to the power supply cable hole is attached.

9. The electric motor according to claim 6, wherein a terminal box bolt-hole pierces through the two attachment surfaces, a bolt to attach the terminal box to the tabular member piercing through the terminal box bolt-hole.

10. An electric motor comprising:
a ring-shaped stator attached to an inside of a tubular body part;
a rotor rotatably arranged inside in a radial direction of the stator;
a tabular member attached to one end of the body part and including a power supply cable through-hole through which a power supply cable to supply electric power to a coil attached to the stator pierces; and
a terminal box which is attached to the tabular member and stores a terminal to which the power supply cable having pierced through the power supply cable through-hole is connected,
wherein the stator and the tabular member are rotatable around a rotation center axis of the rotor, and a position of the power supply cable pulled out from the coil and a position of the power supply cable through-hole can be changed in a circumferential direction of the body part, and
wherein in the terminal box, a power cable introduction part is arranged outside in the radial direction of the body part, a power cable to supply electric power of a power source to the coil being introduced to the terminal through the power cable introduction part.

11. An electric motor comprising:
a ring-shaped stator attached to an inside of a tubular body part;
a rotor rotatably arranged inside in a radial direction of the stator;
a tabular member attached to one end of the body part and including a power supply cable through-hole through which a power supply cable pierces, the power supply cable being pulled out from a coil included by the stator; and
a terminal box which is attached to the tabular member and stores a terminal to which the power supply cable is connected,
wherein the terminal box includes:
a power cable introduction-hole which is arranged outside in the radial direction of body part and leads a power cable to supply electric power of a power source to the coil to the terminal; and
two attachment surfaces which face the tabular member and include a power supply cable hole through which the power supply cable passes.

12. The electric motor according to claim 11, wherein the power supply cable having pierced through the power supply cable through-hole is bent outside in the radial direction of the tabular member and arranged between the two attachment surfaces in a state that the power supply cable is extended outside in the radial direction of the tabular member, and the power supply cable between the two attachment surfaces is arranged at a center of the two attachment surfaces.

13. The electric motor according to claim 11, wherein each of the two attachment surfaces includes a lid bolt hole to which a bolt to attach a lid to the power supply cable hole is attached.

14. The electric motor according to claim 11, wherein a terminal box bolt-hole pierces through the two attachment surfaces, a bolt to attach the terminal box to the tabular member piercing through the terminal box bolt-hole.

15. The electric motor according to claim 11, wherein the power cable can be introduced into the terminal box from one end side or the other end side of the body part through the power cable introduction-hole.
